(19) United States
(12) Patent Application Publication
(10) Pub. No.: US 2016/0319751 A1
(43) Pub. Date: Nov. 3, 2016

(54) DIGITAL LINEAR ACTUATOR LARGE PORT SIDE-GATED CONTROL VALVE FOR ELECTRONIC THROTTLE CONTROL

(71) Applicant: Continental Automotive Systems, Inc., Auburn Hills, MI (US)

(72) Inventors: Craig Andrew Weldon, Chatham (CA); Mordechai Stern, Blenheim (CA)

(21) Appl. No.: 15/068,251

(22) Filed: Mar. 11, 2016

Related U.S. Application Data
(60) Provisional application No. 62/155,679, filed on May 1, 2015.

(51) Int. Cl. F02D 9/14; F16K 1/12; F16K 31/04; F02D 9/02

(52) U.S. Cl. CPC F02D 9/14; F02D 9/02; F16K 1/12; F16K 31/04; F02D 2009/0213

(57) ABSTRACT

A digital linear actuator (DLA) large port throttle control valve manifold assembly which is suitable for use with various automotive engines. The sidegate capnut is sized such that the full amount of throttle body intake manifold air is controlled to the engine. Apertures are formed as part of the side gate capnut to minimize axial air loading on the capnut, providing a pressure balance. Providing a pressure balance also reduces the axial force required to position the capnut, which in turn reduces size of the actuator needed to position the capnut, thus reducing the overall size of the DLA. The positional control of the DLA along with the internal plenum port(s) window profile provides the desired air flow for each commanded position.

### CROSS-REFERENCE TO RELATED APPLICATIONS

This application claims the benefit of U.S. Provisional Application No. 62/155,679 filed May 1, 2015. The disclosure of the above application is incorporated herein by reference.

### FIELD OF THE INVENTION

The invention relates generally to a valve assembly, which includes a digital linear actuator (DLA), where the valve assembly functions as an air control valve.

### BACKGROUND OF THE INVENTION

Typically, gasoline engines having electronic fuel injection (EFI) with a mechanical throttle body (MTB) include a cable driven accelerator, and a digital linear actuator (DLA) type of idle air control valve (IACV). The IACV is designed to meet vehicle emission regulations and account for cable slop and mechanical throttle body air flow and air leak. For larger and more expensive automotive engines, the MTB is being replaced by fully electronic throttle control (ETC). Furthermore, ETC and drive by wire have been steadily replacing MTB applications with EFI. The bore size of the diameter for ETC ranges between 40 millimeters (for a 1.0 L, in-line, three-cylinder engine) to 87 millimeters (for a 6.2 L, 8-cylinder engine). The current designs having ETC are limiting in size due to the size and packing of the gear train, motor, and position sensing elements.

A DLA type of actuator used as an IACV utilizes an annular capnut profile type of valve that changes axial position to control idle air flow. These capnut designs are typically bath tub stopper types of valves, although in some designs, the IACV uses the capnut as a perimeter side gate valve. In any of the above-mentioned designs, the IACV is only used for limited “idle” air to control the engine, and not for controlling the required full intake air volume of an “open” throttle.

Accordingly, there exists a need for a DLA which is size-suitable for smaller automotive engines and provides full electronic throttle control.

### SUMMARY OF THE INVENTION

The present invention is a DLA large port throttle control assembly which is suitable for use with smaller automotive engines. If the sidegate capnut is of sufficient diameter, the full amount of throttle body intake manifold air may be controlled to the engine. One of the features of the invention is to include apertures formed as part of the sidegate capnut to minimize axial differential air loading on the capnut, providing a pressure balance. Providing a pressure balance also reduces the axial force required to position the capnut, which in turn reduces size of the actuator needed to position the capnut, thus reducing the overall size of the DLA. The positional control of the DLA along with the internal plenum port(s) side gate window profile provides the desired throttle air flow for each commanded position.

To reduce the “Reynolds” restrictive flow losses, the throttle body manifold assembly of the present invention includes at least the following two characteristics: 1) the internal plenum ports combined cross-sectional shadow area is greater than or equal to the inlet port cross-sectional shadow area, as well as the outlet port cross-sectional shadow area; and 2) the exterior plenum cavity of the housing surrounding the internal plenum side gate ports is sized sufficiently that the curtain area at the outlet port (the outlet port perimeter×radial clearance between the circumferential wall of the exterior plenum cavity and the outlet port) is larger than the outlet port cross-sectional area. If these two parameters are observed, then the pressure drop through the throttle control assembly of the present invention is minimized or eliminated. The DLA large port throttle control assembly of the present invention is suitable for electronic control with existing stepper motor engine control unit operation parameters. Placement of the internal ports around the circumference of the interior plenum cavity is such to achieve a balanced radial air load on the capnut (i.e., net radial side load force is substantially equal to zero).

In one embodiment, the present invention is a throttle control valve assembly, which includes a housing, an inlet port integrally formed as part of the housing, an outlet port integrally formed as part of the housing, and an interior plenum cavity formed as part of the housing. The inlet port is selectively in fluid communication with the interior plenum cavity through the use of a valve member, which is disposed in the interior plenum cavity. An actuator is connected to the housing, and the valve member is controlled by the actuator. An exterior plenum cavity is formed as part of the housing. The exterior plenum cavity is in fluid communication with the outlet port, and is selectively in fluid communication with the interior plenum cavity. A circumferential wall is formed as part of the housing such that the circumferential wall separates the interior plenum cavity from the exterior plenum cavity, and the valve member is in contact with the circumferential wall. A plurality of internal ports are integrally formed as part of the circumferential wall such the internal ports provide selective fluid communication between the outlet port and the interior plenum cavity, and between the interior plenum cavity and the exterior plenum cavity. The actuator moves the valve member to selectively obstruct the plurality of internal ports to control the flow of air from the inlet port to the outlet port.

The actuator is able to move the valve member to an open position, such that air is able to flow from the inlet port into the interior plenum cavity, where a portion of the air flows through the internal ports and directly to the outlet port, or a portion of the air flows through the exterior plenum cavity and to the outlet port. The actuator also moves the valve member to a closed position, such that the plurality of internal ports are obstructed by the valve member, and air is prevented from flowing from the interior plenum cavity through the exterior plenum cavity, to the outlet port.

In one embodiment, the combined area of the plurality of internal ports is greater than the area of the outlet port, and the combined area of the plurality of internal ports is greater than the area of the inlet port.

The valve member includes a capnut having a first side and a second side, at least one aperture is formed as part of the capnut, and an exterior cylindrical portion is formed as part of the capnut. The exterior cylindrical portion is in sliding contact with the circumferential wall. Air may flow through the aperture formed as part of the capnut to provide a pressure balance on the first side and the second side of the caput. The capnut is moved such that the exterior cylindrical portion selectively obstructs the plurality of internal ports as the caput is moved axially between the open position and the closed position.

In an embodiment, the valve member is a side gate capnut, but it is within the scope of the invention that other types of valve members may be used. Also, the internal ports around the circumference of the interior plenum cavity are positioned as such to achieve a balanced radial air load on the capnut (i.e., the net force radial side load is substantially equal to zero).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a throttle control valve, according to embodiments of the present invention;

FIG. 2 is a side view of a throttle control valve, according to embodiments of the present invention;

FIG. 3 is a sectional side view of a throttle control valve taken along lines 3-3 of FIG. 4;

FIG. 4 is a bottom view of a throttle control valve, according to embodiments of the present invention;

FIG. 5 is a side view of a throttle control valve, according to embodiments of the present invention;

FIG. 6 is a top view of a throttle control valve, according to embodiments of the present invention; and

FIG. 7 is a sectional side view of a throttle control valve taken along lines 7-7 of FIG. 5.

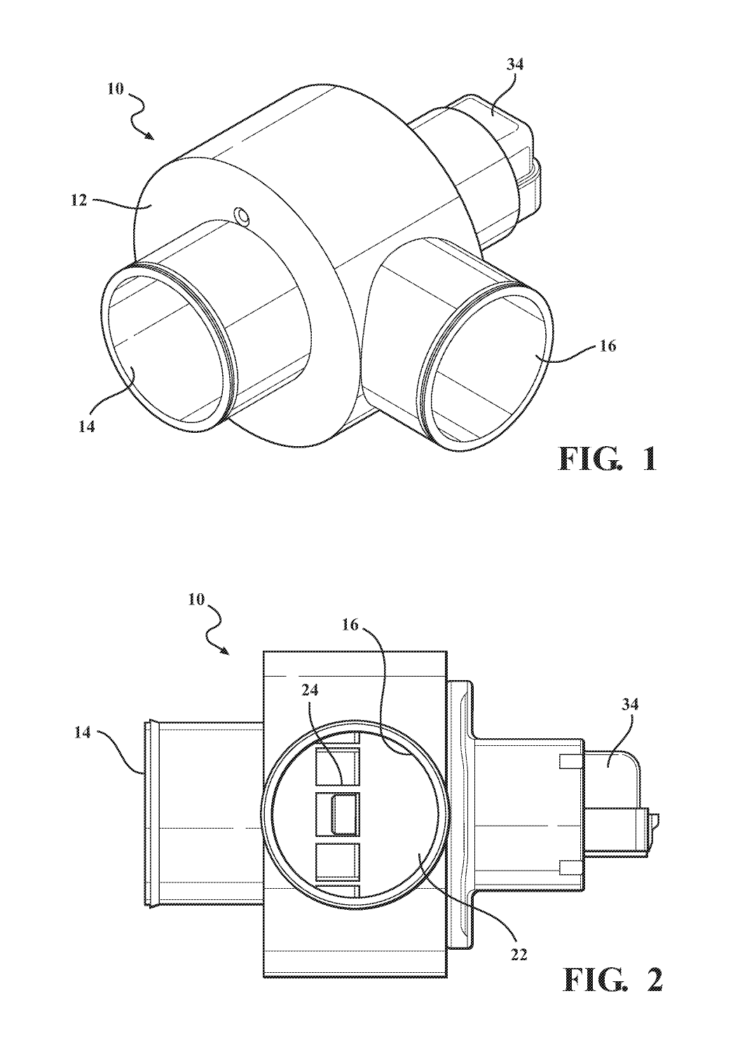

### DETAILED DESCRIPTION OF THE PREFERRED EMBODIMENTS

The following description of the preferred embodiment(s) is merely exemplary in nature and is in no way intended to limit the invention, its application, or uses.

A throttle control valve assembly according to the present invention is shown in the Figures generally at 10. The valve 10 includes a housing 12, and formed as part of the housing 12 is an inlet port 14 and an outlet port 16. Both ports 14,16 are in fluid communication with an interior plenum cavity, shown generally at 18, and the interior plenum cavity 18 is separated from an exterior plenum cavity, shown generally at 20, by a circumferential wall 22. Part of the exterior plenum cavity 20 is also in fluid communication with the outlet port 16, where the portion of the exterior plenum cavity 20 in fluid communication with the outlet port 16 is determined by the diameter of the outlet port 16. Formed as part of the circumferential wall 22 is a plurality of internal ports 24, where the outlet port 16 is in fluid communication with the interior plenum cavity 18 through one or more of the internal ports 24, shown in FIG. 2.

In this embodiment, the internal ports 24 are substantially square-shaped, and are 9.0 millimeters on a side, but it is within the scope of the invention that other shapes and dimensions may be used for desired flow control. The area of each of the internal ports 24 may vary, but regardless of how the internal ports 24 are shaped, the combined area of the internal ports 24 is greater than the area of inlet port 14, and the combined area of the internal ports 24 is also greater than the area of the outlet port 16, so as to reduce or minimize “Reynolds” restrictive flow losses of the air flowing through the valve 10. Also, the exterior plenum cavity 18 of the housing 12 surrounding the internal ports 24 is sized sufficiently that the curtain area at the outlet port 16 (the outlet port perimeter x radial clearance between the circumferential wall 22 of the exterior plenum cavity 20 and the outlet port 16) is larger than the cross-sectional area of the outlet port 16.

Connected to the housing 12 is an actuator, shown generally at 26, which in this embodiment is a stepper motor type of actuator, but it is within the scope of the invention that other types of actuators may be used. The actuator 26 includes a plunger 28, and connected to the plunger 28 is a valve member, which in this embodiment is a side gate capnut 30. The capnut 30 is in sliding contact with the interior plenum surface of the circumferential wall 22. The capnut 30 includes a central valve plate 30d, and formed as part of the central valve plate 30d is a plurality of apertures 32. The apertures 32 provide a way to ensure a pressure balance axially between a first side 30a of the central valve plate 30d, and a second side 30b of the central valve plate 30d, as the capnut 30 is moved relative to the circumferential wall 22. The interior plenum cavity 18 is divided into two volumes by the central valve plate 30d, a first interior volume, shown generally at 18a located between the central valve plate 30d and a valve seat 38 formed as part of the inlet port 14, and a second interior volume, shown generally at 18b located between the central valve plate 30d and a back wall 12a of the housing 12.

There is also a connector, shown generally at 34, which is in electrical communication with the actuator 26. The actuator 26 is activated when a current is applied to the actuator 26 through the connector 34. The direction which the plunger 28 travels to move the capnut 30 is controlled by the actuator 26. The plunger 28 and capnut 30 are shown axially and radially fixed, however, in other embodiments, there is radial freedom provided to the capnut 30 which would compensate for axial misalignment, and the resulting travel path of the capnut 30. When the plunger 28 travels in a first, or retract, direction, the capnut 30 moves towards the actuator 26 along an axis 36 that extends through the plunger 28, and when the plunger 28 travels in a second, or extend, direction, the capnut 30 moves away from the actuator 26 along the axis 36. When in the closed position, the capnut 30 is in contact with the valve seat 38. The capnut 30 also includes an exterior cylindrical portion 30c which is in close sliding contact with interior of the circumferential wall 22. The exterior cylindrical portion 30c fully obstructs the flow of air through the internal ports 24 when the capnut 30 is extended forward to the closed position.

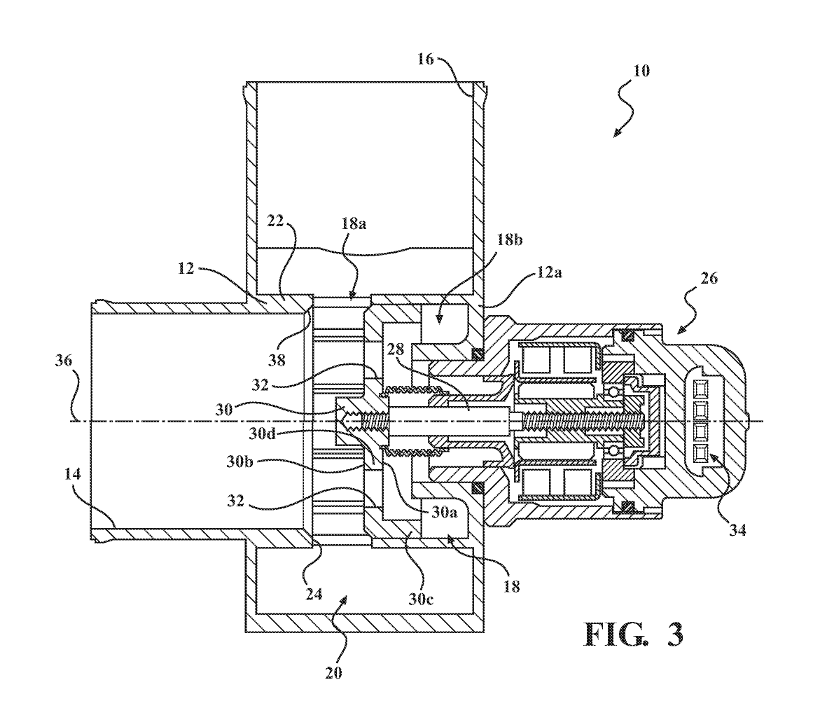

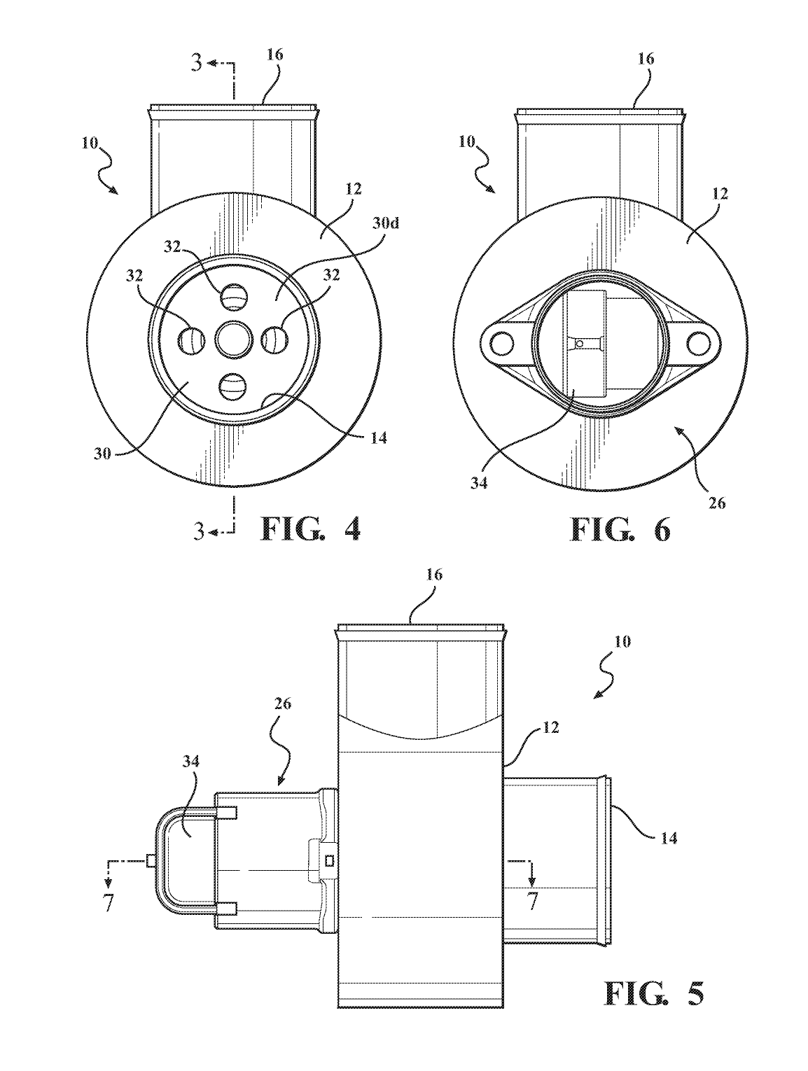

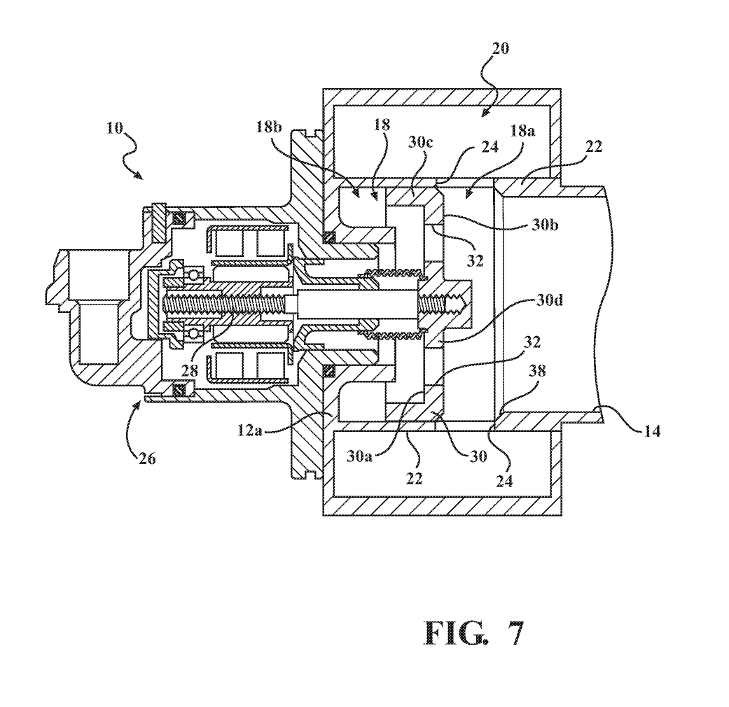

In FIG. 3, the capnut 30 is shown in the fully open position, where the internal ports 24 are completely unobstructed by the exterior cylindrical portion 30c. When in the open position, air flows from the inlet port 14, into the interior plenum cavity 18. A portion of the air flows into the first interior volume 18a, and a portion of the air flows into the second interior volume 18b because of the air passage through the apertures 32. The air may also flow between the two interior volumes 18a,18b during the operation of the valve 10, and may fluctuate based on the position of the capnut 30. The portion of air that flows into each of the interior volumes 18a,18b depends on the position of the capnut 30. Additionally, as the position of the capnut 30 changes, the size of each of the interior volumes 18a,18b changes as well. The air flows through the apertures 32 to provide a pressure balance on each side 30a,30b of the central valve plate 30, regardless of the position of the central valve plate 30. Placement of the internal ports 24 around the circumferential wall 22 is such to achieve a balanced radial air load on the capnut 30 (i.e., net side load force is substantially equal to zero).

During operation, when the capnut 30 is moved away from the valve seat 38, the air in the first interior volume 18a flows through the internal ports 24. After the air passes through the internal ports 24, a portion of the air flows directly into the outlet port 16, and a portion of the air flows into the exterior plenum cavity 20, and then into the outlet port 16. The configuration of the internal ports 24 and the exterior plenum cavity 20 provides for a higher maximum flow capacity between the inlet port 14 and outlet port 16, as opposed to a configuration where the internal ports 24 are formed as part of the circumferential wall 22 in close proximity to the outlet port 16.

The actuator 26 is controlled to move the sidegate capnut 30 between the open position as shown in FIG. 3, to the closed position, such that the capnut 30 is moved away from the actuator 26, where the capnut 30 contacts the valve seat 38, the internal ports 24 are blocked by the exterior cylindrical portion 30c, and the inlet port 14 is no longer in fluid communication with the outlet port 16. When the capnut 30 is in contact with the valve seat 38, the first interior volume 18a is essentially reduced to zero. However, there is still air in the second interior volume 18b because the air is still allowed to flow through the apertures 32 of the central valve plate 30d when the capnut 30 is in contact with the valve seat 38. The capnut 30 is also capable of being selectively placed in any location between the fully open and closed positions to configure the exterior cylindrical portion 30c to partially obstruct the internal ports 24, to control the flow of air between the inlet port 14 and outlet port 16.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a valve assembly, including:
an actuator;
a valve member moveable between an open position and a closed position, the valve member connected to the actuator; and
a housing having an inlet port and an outlet port;
wherein the actuator controls the movement of the valve portion between the open position and the closed position to control the flow of air between the inlet port and the outlet port.

2. The apparatus of claim 1, further comprising:
an interior plenum cavity formed as part of the housing, selectively in fluid communication with the inlet port;
an exterior plenum cavity formed as part of the housing and in fluid communication with the outlet port;
a circumferential wall formed as part of the housing, separating the interior plenum cavity and the exterior plenum cavity; and
at least one internal port formed as part of the circumferential wall, the at least one internal port providing fluid communication between the interior plenum cavity and the exterior plenum cavity;
wherein the valve member moves along the circumferential wall to selectively block at least a portion of the at least one internal port, and controlling the flow of air from the inlet port into the interior plenum cavity, into the exterior plenum cavity, and through the outlet port.

3. The apparatus of claim 2, the at least one internal port further comprising a plurality of internal ports formed as part of the circumferential wall.

4. The apparatus of claim 2, the valve member further comprising a side gate capnut.

5. The apparatus of claim 4, the side gate capnut further comprising:
at least one aperture formed as part of the capnut;
wherein air flows through the at least one aperture formed as part of the capnut to provide a pressure balance on a first side and a second side of the caput.

6. The apparatus of claim 4, the capnut further comprising:
an exterior cylindrical portion formed as part of the capnut, the exterior cylindrical portion in sliding contact with the circumferential wall;
wherein the capnut is moved such that the exterior cylindrical portion selectively obstructs the plurality of internal ports as the caput is moved between the open position and the closed position.

7. The apparatus of claim 2, wherein the actuator moves the valve member to an open position, where air is able to flow from the inlet port into the interior plenum cavity, where a portion of the air flows through the at least one internal port directly to the outlet port, and a portion of the air flows through the at least one internal port, through the exterior plenum cavity, and to the outlet port.

8. The apparatus of claim 2, wherein the actuator moves the valve member to a closed position, such that the at least one internal port is obstructed by the valve member, and air is prevented from flowing from the interior plenum cavity through the exterior plenum cavity to the outlet port.

9. The apparatus of claim 2, wherein the area of the at least one internal port is greater than the area of the outlet port.

10. The apparatus of claim 2, wherein the area of the at least one internal port is greater than the area of the inlet port.

11. A valve assembly, comprising:
a housing;
an inlet port formed as part of the housing;
an outlet port formed as part of the housing such that the outlet port is selectively in fluid communication with the inlet port;
an actuator connected to the housing;
a valve member connected to and controlled by the actuator, the valve member located in the housing between the inlet port and the outlet port;
a circumferential wall formed as part of the housing, the valve member in contact with the circumferential wall; and
a plurality of internal ports formed as part of the circumferential wall;
wherein the actuator moves the valve member between an open position, such that air passes from the inlet port, through the plurality of internal ports, and through the outlet port, and the actuator moves the valve member to a closed position, where the valve member obstructs the plurality of internal ports, preventing the flow of air from the inlet port to the outlet port.

12. The valve assembly of claim 11, further comprising:
an interior plenum cavity formed as part of the housing, the valve member located in the cavity; and
an exterior plenum cavity formed as part of the housing, the circumferential wall separating the interior plenum cavity from the exterior plenum cavity;
wherein air flows from the inlet port into the interior plenum cavity when the valve member is in the open position such that the air flows through the plurality of internal ports, where a portion of the air flows to the outlet port, and a portion of the air passes through the exterior plenum cavity and then to the outlet port.

13. The valve assembly of claim 11, wherein the combined area of the plurality of internal ports is greater than the area of the outlet port.

14. The valve assembly of claim 11, wherein the combined area of the plurality of internal ports is greater than the area of the inlet port.

15. The valve assembly of claim 11, the valve member further comprising a capnut.

16. The valve assembly of claim 15, the capnut further comprising:
at least one aperture formed as part of the capnut;
wherein air flows through the at least one aperture formed as part of the capnut to provide a pressure balance on a first side and a second side of the caput.

17. The valve assembly of claim 15, the capnut further comprising:
an exterior cylindrical portion formed as part of the capnut, the exterior cylindrical portion in sliding contact with the circumferential wall;
wherein the capnut is moved such that the exterior cylindrical portion selectively obstructs the plurality of internal ports as the caput is moved between the open position and the closed position.

18. A throttle control valve assembly, comprising:
a housing;
an inlet port integrally formed as part of the housing;
an outlet port integrally formed as part of the housing;
an interior plenum cavity formed as part of the housing, the inlet port selectively in fluid communication with the interior plenum cavity;
a valve member disposed in the interior plenum cavity;
an actuator connected to the housing, the valve member controlled by the actuator;
an exterior plenum cavity formed as part of the housing, the exterior plenum cavity in fluid communication with the outlet port, and the exterior plenum cavity selectively in fluid communication with the interior plenum cavity;
a circumferential wall formed as part of the housing such that the circumferential wall separates the interior plenum cavity from the exterior plenum cavity, the valve member being in contact with the circumferential wall; and
a plurality of internal ports integrally formed as part of the circumferential wall, the plurality of internal ports providing selective fluid communication between the outlet port and the interior plenum cavity, and between the interior plenum cavity and the exterior plenum cavity;
wherein the actuator moves the valve member to selectively obstruct the plurality of internal ports to control the flow of air from the inlet port to the outlet port.

19. The throttle control valve assembly of claim 18, wherein the actuator moves the valve member to an open position, such that air is able to flow from the inlet port into the interior plenum cavity, where a portion of the air flows through the internal ports and either directly to the outlet port, and a portion of the air flows through the exterior plenum cavity and to the outlet port.

20. The throttle control valve assembly of claim 18, wherein the actuator moves the valve member to a closed position, such that the plurality of internal ports are obstructed by the valve member, and air is prevented from flowing from the interior plenum cavity through the exterior plenum cavity to the outlet port.

21. The throttle control valve assembly of claim 18, wherein the combined area of the plurality of internal ports is greater than the area of the outlet port.

22. The throttle control valve assembly of claim 18, wherein the combined area of the plurality of internal ports is greater than the area of the inlet port.

23. The throttle control valve assembly of claim 18, the valve member further comprising:
a capnut having a first side and a second side;
at least one aperture formed as part of the capnut; and
an exterior cylindrical portion formed as part of the capnut, the exterior cylindrical portion in sliding contact with the circumferential wall;
wherein air flows through the at least one aperture formed as part of the capnut to provide a pressure balance on the first side and the second side of the caput, and the capnut is moved such that the exterior cylindrical portion selectively obstructs the plurality of internal ports as the caput is moved between the open position and the closed position.
